(19) United States
(12) Patent Application Publication
(10) Pub. No.: US 2013/0325522 A1
(43) Pub. Date: Dec. 5, 2013

(54) CHARTERING CRAFT INDEPENDENT OF THE LOCATION OF CRAFT OR BUSINESS LOCATION OF A CHARTER OPERATOR

(71) Applicant: Stephen Wu, Bellevue, WA (US)

(72) Inventor: Stephen Wu, Bellevue, WA (US)

(21) Appl. No.: 13/487,137

(22) Filed: Jun. 1, 2012

(51) Int. Cl. G06Q 10/02

(52) U.S. Cl. 705/5

(57) ABSTRACT

According to a computer-implemented approach for managing and chartering readily transportable watercraft, vessels, vehicles and other charter craft, customers are able to view and specify where they wish to charter such craft independent of where a charter craft might be permanently stored or regularly parked, berthed or moored. According to the approach, customers provide their desired charter location where they would like to charter craft. Customers are then provided in response with a list of matching locations and charter rates for one or more charter craft to be delivered at the desired charter location. After completing charter arrangements, the charter operator delivers to the customer their selection of charter craft to the specified charter location and upon completion of the charter, also retrieves the charter craft from an agreed upon retrieval location. The charter operator may be either centralized or distributed and may be a single or multiple organization(s).

### TECHNICAL FIELD

The present invention relates to the management of a pool of transportable watercraft, vessels, recreational vehicles, motorcycles and more specifically, to an approach for chartering these craft (“charter craft” or “craft” is hereinafter used to refer to all such objects) to customers at locations selected by the customers; rather than at locations dictated by or limited to the moorage, storage, parking or otherwise permanent location of the craft; or by the physical place of business of a charter operator.

### BACKGROUND

Conventional chartering methods and models for charter crafts are typically based upon chartering these craft at locations where their owners or operators have these craft are moored, berthed or primarily stored, or where a charter operator has their location of business. Frequently, as in the example of boats, these craft or vessels are too large to transport readily, or require special routes or forms of transport; and are therefore limited to specific charter locales and/or navigable waterways. Furthermore, operators that offer craft for charter do not have the capability to support the chartering-out of charter craft at random locations; or more specifically and as it relates to this invention—at locations specified by the customer chosen without regard for the availability of charter craft at a specific location. Instead, the traditional model for chartering craft forces customers to (i) select locations from a set list offered by charter operators and; then furthermore (ii) to select charter craft from whatever inventory an operator might have at that location that are available for the customers' desired charter period timeframe.

These types of conventional chartering models suffer from several significant limitations. First, charter customers are confined to a limited number of charter locations. For example, in the chartering of boats—only the most popular navigable waterways—are served by operators with a limited range and number of vessels for charter. Second, charter customers not only have limited locations where they can charter craft, but there are usually only a limited number of craft for charter at those locations! Third, charter craft owners typically do not receive significant revenue yields from their charter craft due to seasonal factors. Again, in the case of the boat chartering example, bareboat vessel charters in the Pacific Northwest of the USA commonly only generate charter revenues for just a few weeks each year! Fourth and compounding the three limitations just described—there are no efficient marketplace solutions for facilitating the chartering of craft at diverse locations.

Given the limitations in the prior approaches, an approach for chartering craft to customers that does not suffer from the limitations associated with conventional models is highly desirable. In particular, an approach for allowing charter customers to specify what locations they wish to charter at—without regard for whether or not a charter operator has a facility at that location—is highly desirable. Additionally, an approach for bringing or transporting charter craft to a charter location once such location is selected is highly desirable. Additionally, an approach for charter owners that enables them to increase their charter yields is also highly desirable.

There is yet a further need for an approach for facilitating an efficient and flexible solution for specifying, selecting and chartering craft from a wide variety of charter locations and charter craft; and once a charter agreement is in place between a charter customer and charter operator—for managing the interaction of those customers with operators to facilitate and minimize any administrative friction that might arise from the management of a charter agreement and contract between charter customers and operators.

### SUMMARY

This invention deals with the charter of watercraft, vessels, RVs and other such craft to charter customers by charter operators. For simplicity and clarity of explanation, the terms “charter craft” or “craft” are used interchangeably herein to refer to any and all of these objects, without prejudice or intent to increase or diminish the value of the invention as it might relate to any of these objects. Similarly, the term “charter customers” or “customers” refers to customers who will charter craft.

According to one aspect of the invention, a method is provided for creating and maintaining an inventory of charter craft by one or more operators. According to the method, data are received about charter craft that include attributes that define or characterize a charter craft including but not limited to its capacities and capabilities, dimensions, performance data, and so on.

According to one aspect of the invention, a method is provided for creating and maintaining a list of desirable charter locations for chartering craft. The method also allows for the determination of whether or not a charter location is suitable (or navigable) for charter craft. According to the method, such data are received that include attributes including but without limitation to: maps, points of interest, annual climate and weather conditions, boat launch locations, depth of waterways, local boating regulations, and so on.

According to another aspect of the invention, a method is provided for chartering craft to customers. According to the method, one or more charter location selection criteria are received that indicate one or more charter locations at which a customer desires to charter one or more craft. Furthermore, charter location selection criteria also include a charter starting point and a charter ending point, wherein these points need not be identical.

According to another aspect of the invention, a method is provided whereby charter location selection criteria having been satisfied and matching or closely matching locations having been identified, a list of charter craft that can be delivered to such location(s) and the cost to charter such craft(s) at such location(s) is provided to the customer. Such cost to charter including analyses of the various economical and logistical approaches and solutions for delivering and retrieving charter craft to and from the various charter location matches.

According to another aspect of the invention, and in response to one or more of these various selection criteria being satisfied, and in response to the customer making one or more choices of the various options, one or more charter itineraries are created. Every charter itinerary having data that includes but is not limited to: one or more charter craft, a charter location, a charter starting point, a charter ending point, charter starting and ending dates and times, charter pricing, as well as other relevant information.

According to another aspect of the invention, a method is provided to enable customers to enter into charter agreements and relationship with operators and make deposits against and payments for charter itineraries.

According to another aspect of the invention, a method is provided for managing the charter agreements and relationships between charter customers and the charter operators, including all facets of multimodal communication (i.e. voice, SMS, video, email and so on) and customer care.

According to one aspect of the invention, a computer-implemented method is provided for creating and maintaining an inventory of charter craft by one or more operators. According to the method, data are received about charter craft that include attributes that define or characterize a charter craft including but not limited to its capacities and capabilities, dimensions, age, performance data, and so on.

According to another aspect of the invention, a computer-implemented method is provided for creating and maintaining a list of desirable locations for chartering craft. The method also allows for the determination of whether or not a charter location is suitable (or navigable) for charter craft. According to the method, such data are received that include attributes including but without limitation to: maps, points of interest, annual and present climate and weather conditions, boat launch locations, depth of waterways, local boating regulations, and so on.

According to another aspect of the invention, a computer-implemented method is provided for chartering charter craft to customers. According to the method, one or more charter location selection criteria are received that indicate one or more charter locations at which a customer desires to charter one or more craft. Furthermore, charter location selection criteria also include a charter starting point and a charter ending point, wherein these points need not be identical.

According to another aspect of the invention, a computer-implemented method whereby charter location selection criteria having been satisfied and matching or closely matching locations having been identified, a list of charter craft that can be delivered to such location(s) and the cost to charter such craft(s) at such location(s) is provided to the customer. Such cost to charter including analyses of the various economical and logistical approaches and solutions for delivering and retrieving charter craft to and from the various charter location matches.

According to another aspect of the invention, a computer-implemented method is provided whereby in response to one or more of these various selection criteria being satisfied, and in response to the customer making one or more choices of the various options, one or more charter itineraries are created. Every charter itinerary having data that includes but is not limited to: one or more charter craft, a charter location, a charter starting point, a charter ending point, charter starting and ending dates and times, charter pricing, as well as other relevant information.

According to another aspect of the invention, a computer-implemented method is provided to enable customers to enter into charter agreements and relationship with operators and make deposits against and payments for charter itineraries.

According to one aspect of the invention, a computer-implemented method is provided for managing the charter relationship between charter customers and charter operators, including all facets of multimodal communication (i.e. voice, SMS, video, email and so on) and customer care.

According to another aspect of the invention, an apparatus is provided for facilitating the collection and storage of data regarding desirable charter locations and where chartering craft would be desirable. The apparatus comprises data collection mechanisms configured to receive data including whether or not a charter location is suitable (or navigable) for charter craft. According to the method, such data are received that include attributes including but without limitation to: maps, places of interest, annual and present climate and weather conditions, boat launch locations, depth of waterways, local boating regulations, and so on. The apparatus comprises one or more processors and a memory communicatively coupled to the one or more processors. The memory includes one or more sequences of one or more instructions which, when executed by the one or more processors, cause the one or more processors to perform several steps. For example, data are received and stored and such data can be modified or updated at anytime. Such data can be manually entered or electronically transferred via an automatic process (so-called “batch upload”). Then, in response to queries from customers, such data can be used for example, to populate or provide a list of matching charter locations for a customer. In addition, multiple stores of data could exist, without limitation, to facilitate the methods and apparatus described herein.

According to another aspect of the invention, an apparatus is provided for facilitating the collection and storage of data that are used to characterize or define a charter craft. The apparatus comprises one or more processors and a memory communicatively coupled to the one or more processors. The memory includes one or more sequences of one or more instructions which, when executed by the one or more processors, cause the one or more processors to perform several steps. The apparatus comprises data collection mechanisms configured to receive data including but not limited to: charter craft attributes such as capacities and capabilities, performance characteristics, operations and maintenance guides, and so on. This data could also include temporal and related data elements, such as the present location of a charter craft and data about transport costs from some locations. Data are received and stored and such data can be modified or updated at anytime. Such data can be manually entered or electronically transferred via an automatic process (so-called “batch upload”). In response to queries from customers, such data can be used to populate or provide a resolution for a list of matching charter craft for a customer. In addition, multiple stores of data could exist, without limitation, to facilitate the methods and apparatus described herein.

According to another aspect of the invention, an apparatus is provided for chartering craft to customers. The apparatus comprises one or more processors and a memory communicatively coupled to the one or more processors. The memory includes one or more sequences of one or more instructions which, when executed by the one or more processors, cause the one or more processors to perform several steps. The apparatus can be configured to receive one or more charter craft selection criteria that comprise key charter agreement attributes including but not limited to: charter craft, charter start date, charter ending date, charter location, charter delivery location, charter retrieval location, and so on. The apparatus is also configured to provide to the customer a list of charter craft for consideration that match or closely-match the charter location selection criteria and upon further selection by the customer—create one or more charter itineraries matching the various charter selection criteria. The apparatus is also configured to—in response to one or more selection criteria being satisfied—provide to the customer a charter receipt and/or agreement in response to a full payment; or in the event of a partial payment or reservation without payment, an electronic token confirming or as evidence of a transaction that can then be used in future to finalize a charter arrangement.

According to another aspect of the invention, an apparatus is provided for managing the charter relationship between charter customers and charter operators. The apparatus comprises one or more processors and a memory communicatively coupled to the one or more processors. The memory includes one or more sequences of one or more instructions which, when executed by the one or more processors, cause the one or more processors to perform several steps. The apparatus can be configured to facilitate communications and information exchange between charter customers and charter operators and any combination thereof and can include voice, video, written or other forms of multimodal communication and information exchange without limitations.

### BRIEF DESCRIPTION OF DRAWINGS

Various ones of the appended drawings merely illustrate exemplary embodiments of the present invention and cannot be considered as limiting its scope.

FIG. 1 is a block diagram depicting an overall functional overview of an approach for chartering craft independent of the location of such craft or the business location of a charter operator according to an embodiment;

FIG. 2 is a flow diagram depicting an approach for chartering craft independent of the location of such craft or the business location of a charter operator according to an embodiment;

FIG. 3 is a flow diagram depicting an approach for facilitating a “Close But No Exact Match” process for chartering craft independent of the location of such craft or the business location of a charter operator according to an embodiment;

FIG. 4 is a block diagram depicting an approach for chartering watercraft/vessels over the Internet according to an embodiment; and

FIG. 5 is a block diagram of a computer system upon which embodiments of the invention may be implemented.

### DETAILED DESCRIPTION

In the following description, for the purposes of explanation, specific details are set forth in order to provide a thorough understanding of the invention. However, it will be apparent to those skilled in the art that embodiments of the inventive subject matter may be practiced without these specific details. In other instances, well-known structures and devices are depicted in block diagram form in order to avoid unnecessarily obscuring the invention. The description that follows includes illustrative systems, methods, techniques, and instruction sequences that embody the inventive subject matter. Further, well-known instruction instances, protocols, structures, and techniques have not been shown in detail.

Various aspects and features of example embodiments of the invention are described in more detail hereinafter in the following sections: (A) functional overview; (B) charter location selection criteria; (C) charter craft selection criteria; (D) charter craft delivery; (E) charter craft retrieval; (F) inventory management; and (G) implementation mechanisms.

### (A)—Functional Overview

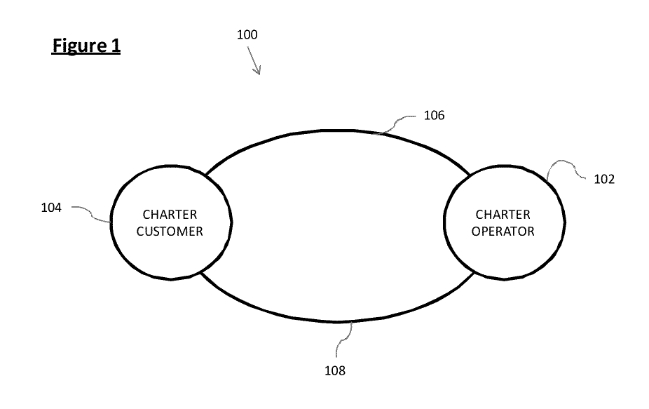

FIG. 1 is a block diagram 100 that illustrates an approach for collecting charter craft attributes about charter craft according to the various embodiments described herein. As used herein, the term “charter craft” refers to any watercraft, marine vessel, RV, motorcycle or vehicle or other craft offered for charter to one or more customers. As used herein, the term “charter craft attributes” refers to data and information about charter craft, including but not limited to: capacities and dimensions, age, performance capabilities, and so on.

In this approach, the decision of what craft to charter is separated from the decision of where to charter such craft. Customers may first specify where they wish to start their charter, by specifying one or more charter location selection criteria, separate from deciding what type of craft they wish to charter.

Customers may also specify where they wish to end their charter(s) through their charter location selection criteria, where the starting location and ending locations need not be identical.

In addition, customers can specify additional charter locations they would like to visit during their charter(s); whereby the operator may transport the charter craft to on behalf of the customers, potentially for additional fees.

This allows customers to have a much wider selection of locations to charter at; since they are not primarily limited to specific charter venues.

Furthermore, customers are not constrained by what craft are available at their specific desired time of charter, and instead can have much greater possibilities of chartering at their desired time since this invention contemplates charter craft that can be transported and delivered to customers over roadways and other modes of transportation from other locations.

According to one embodiment, a customer 102 provides one or more charter location selection criteria to a charter operator (shown simply as “operator”) 104 over a link 106. Link 106 may be any medium for transferring data between customer 104 and operator 104 and the invention is not limited to any particular medium. Examples of link 106 include, without limitation, a network such as a LAN, WAN or the Internet, a telecommunications link, a wire or optical link or a wireless connection.

The charter location selection criteria indicate the locations where customer 102 desires to charter one of more craft from operator 104 as well as where the customer desires to end their charter; and optionally—any additional locations that the customer may wish to visit during their charter. In response to receiving the charter location selection criteria from customer 102, operator 104 provides a list of charter locations that match (or closely match those indicated by the charter location selection criteria) to customer 102 over a delivery channel 108.

### Close But Not Exact Match

A situation might arise that if the provided charter locations are not satisfactory to customer 102, customer 102 may request that new charter locations be added that more closely match the provided charter location selection criteria. Operator 104 may compute the feasibility of such a request and if allowable, add such new location to the list of charter locations. This situation is known as a “Close But Not Exact Match” case; which is described in greater detail in Section (C)—Charter Location Selection Criteria.

Delivery channel 108 may be implemented by any mechanism or medium that provides for the transfer of charter craft from operator 104 to customer 102 and the invention is not limited to any particular type of delivery channel. Examples of delivery channel 108 include, without limitation, towing overland by road, delivery by ocean or cargo transport, train and also via a dedicated or third party delivery agent. Operator 104 may be centralized or distributed or even a cooperative affiliation of operators—depending upon the requirements of a particular application.

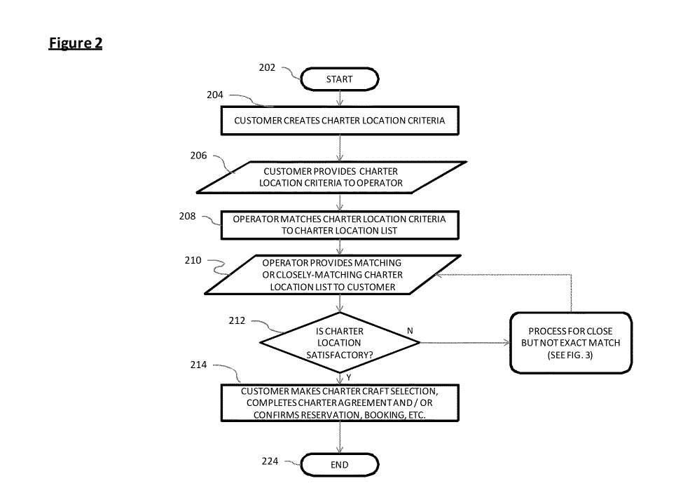

The approach just described for chartering craft to customers is now described with reference to a flow diagram 200 of FIG. 2.

After starting in step 202, in step 204, a customer creates charter location selection criteria. In step 206, the customer provides the charter location selection criteria to the operator. In step 208, in response to the operator receiving the charter location selection criteria from the customer, the operator provides one or more matching or closely-matching charter locations as by the charter location selection criteria to the customer in step 210. If the provided charter locations in step 212 are satisfactory, then the customer proceeds to step 214.

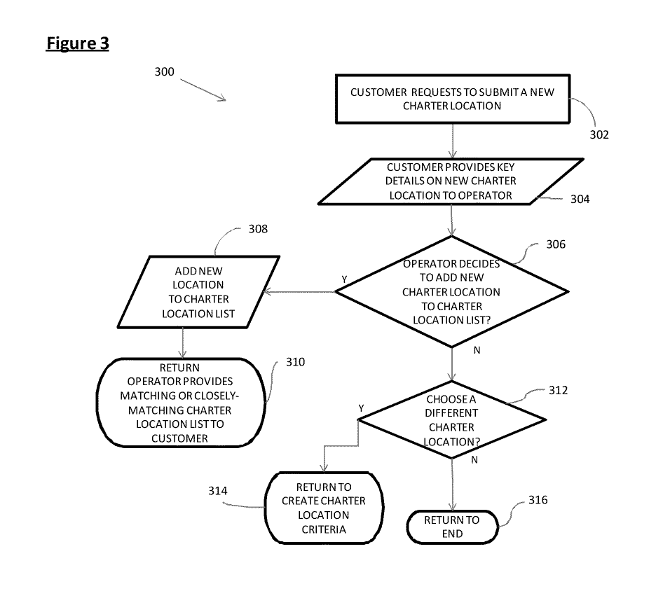

If the provided charter locations are not satisfactory to the customer, then the customer is provided the option to begin a process known as “Close But Not Exact Match” in step 216 whereby a customer may request that an additional charter location be added to the charter locations list. This process for “Close But Not Exact Match”, is shown and described in FIG. 3. Depending on the outcome of the “Close But Not Exact Match” process, the customer may return to step 214.

When customer enters step 214, they will select a charter craft type, agree on pricing and delivery mechanism and complete a reservation agreement or some form of contract. The process is complete in step 218.

### (B)—Charter Location Selection Criteria

Referring now to FIG. 1, the one or more charter location selection criteria provided by customer 102 to operator 104 indicate the particular charter locations that customer 102 wishes to charter craft at from operator 104.

The charter location selection criteria include (but are not limited to) the following: a charter starting point, at a charter location, a charter ending point, at a charter location. The charter starting and ending points do not need to be identical. If multiple destinations are intended to be included in a charter whereby the operator will transport the charter craft on behalf of the customer during the course of their charter, then additional pickup and drop-off points will be included in the charter location selection criteria.

An example of this could be a boat charter customer who wishes to start their charter on the East Coast of the USA, and end their charter on the West Coast of the USA, and have multiple scheduled stops at the Great Lakes in between.

Additionally, the charter location selection criteria define a customer-specific list of desired charter locations that can also be stored for ease-of-access by operator 104.

According to one embodiment, the charter location selection criteria specify attributes of specific charter locations offered by operator 104 to customer 102. Charter location selection criteria may specify any type of location attributes and the invention is not limited to particular charter location attributes. Examples of charter location selection attributes include, without limitation, distance from towns, location-specific attributes such as local drop-off and pickup points at locales, geographical attributes and transportation cost attributes. Charter location selection criteria may be changed at any time to reflect changes in charter locations where customers desire to charter craft from operators.

When a charter location desired by a customer is not one currently supported by an operator, the customer is provided with the option to request that their desired location be added to the operator's list as a new location. This process is known as “Close But Not Exact Match” and the data flow diagram for this process is described now in FIG. 3.

The “Close But Not Exact Match” process begins in step 302 with a request from a customer to add a new charter location. In step 304, the customer provides key details of their desired, new charter location for submission to the operator. These key details would include (without limitation): city, state/province, and address details, geographic, topical and other information. In step 306, the operator may decide to add the submitted new charter location to their list of charter locations in step 308, after which returning the customer to continue with their charter process as shown and described previously in FIG. 2.

If the operator decides not to add the new charter location in step 306, then the customer is: offered the option of choosing a different charter location in step 312, and is then returned to either complete their reservation (as shown previously in FIG. 2); or the customer may exit their reservation process depending on their decision at step 312.

### (C)—Charter Craft Selection Criteria

Referring now to FIG. 1, the one or more charter craft selection criteria provided by customer 102 to operator 104 indicate the particular type of charter craft that customer 102 wishes to charter from operator 104. For example, customer 102 may wish to charter a boat that sleeps four people and has a fast turn of speed.

Thus, the charter craft selection criteria define a customer-specific list of desired charter craft that can be stored for ease-of-access by operator 104. According to one embodiment, the charter craft selection criteria specify attributes of specific charter craft offered by operator 104 to customer 102.

Charter craft selection criteria may specify any type of charter craft attributes and the invention is not limited to particular charter craft attributes. Examples of charter craft selection attributes include, without limitation, number of beds in a craft capable of sleeping accommodations, number of engines, speed and range capabilities, transportation cost attributes and so on. Charter craft selection criteria may be changed at any time to reflect changes in the type of charter craft that customers desire to charter from a charter operator.

### (D)—Charter Craft Delivery

According to one embodiment, and referring to FIG. 1, charter craft are delivered by operator 104 to customer 102 over delivery channel 108 based upon charter craft delivery criteria. More specifically, the delivery of charter craft from operator 104 to customer 102 is determined and computed using various data provided by the charter customer, charter operator, and publicly available secondary data that are collectively used to determine the optimal manner in which a charter craft might be delivered to the customer at the charter location. The charter craft delivery criteria may include a wide range of criteria and the invention is not limited to any particular delivery criteria. Examples of charter craft delivery criteria include, dimensions of the charter craft being delivered, distance from the present position of the charter craft to the charting starting point at the charter location, the duration of the charter period and so on. Examples of delivery modes and agents include, without limitation, overland by road, overseas by cargo carrier, and so on.

The charter craft delivery criteria may be specified by customer 102 to operator 104 or negotiated by customer 102 and operator 104 as part of a charter craft agreement. For example, a particular charter rate for a particular charter location might vary from one day to the next based on the available of a charter craft at a nearby location. Therefore customer 102 might choose to delay the start of their charter with operator 104 to take advantage of such a lower charter rate.

### An Example of Chartering Watercraft or Vessels Over the Internet According to the an Embodiment of the Invention.

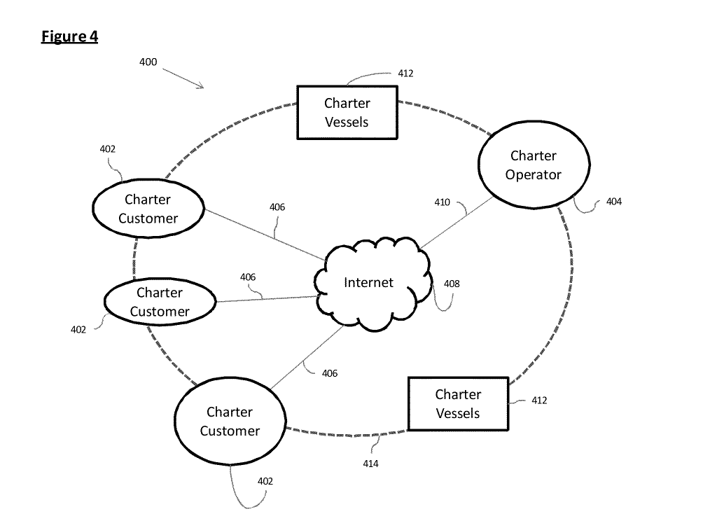

The approach for charter craft described herein is now described in the context of chartering watercraft and vessels to customers. FIG. 4 is a diagram 400 that depicts a set of customers 402 that desire to charter craft from a charter operator 404. Customers 402 communicate with operator 404 over links 406, the global packet-switched network referred to as the “Internet,” and a link 410.

Links 406 and 410 may be any medium for transferring data between customers 402 and the Internet 408 and between the Internet 408 and operator 404, respectively, and the invention is not limited to any particular medium. In the present example, links 406 and 410 may be connections provided by one or more Internet Service Providers (ISPs) and customers 402 are configured with generic Internet web browsers or dedicated software applications running on PCs, mobile devices, and so on. Links 406 and 410 may be secure or unsecured depending upon the requirements of a particular application.

In accordance with an embodiment, customers 402 are able to provide charter location selection criteria to operator 404 to specify their requirements for chartering craft. Through the approach described herein they are able to narrow down a list of matching or closely-matching charter itineraries that match customers 402 various selection criteria. Customers 402 may optionally create customer accounts before defining charter location selection criteria, or may do so later. The invention is not limited to any particular approach for entering into a charter agreement with or creating a customer account with the operator. For example, customers 402 and operator 404 may enter into a charter agreement by mail, telephone or over the Internet, or by customers 402 logging into a web site associated with operator 404.

Customers 402 create and provide charter location and other selection criteria to operator 404 over links 406 and 410 and the Internet 408. The invention is not limited to any particular approach for specifying and providing charter location or other selection criteria to operator 404. For example, according to one embodiment, customers 402 provide charter location selection criteria to operator 404 in one or more data files. According to another embodiment, customers 402 log onto a web site of operator 404 and use a graphical user interface (GUI) to specify attributes of the locations, craft and charter starting and ending dates that customers wish for their charter from operator 404.

The various charter selection criteria may include any attributes that describe, at least in part, a charter location, type of craft, sleeping berths, speed and performance, range and charter dates that customers 402 desire to rent. Customers 402 may identify charter profiles as part of their various charter selection criteria, thereby enabling operator 404 with enough information to automatically select particular charter locations and charter craft that match or closely-match those criteria characterized by the profiles provided by customers 402.

Once customers 402 and operator 404 have selected and or created one or more charter itineraries and entered into a charter agreement, then operator 404 delivers charter craft 412 to customers 402 over delivery channels 414 in accordance with the terms of the charter agreement.

Operator 404 is illustrated as a single entity for purposes of explanation only. Operator 404 may be centralized or distributed depending upon the requirements of a particular application. For example, operator 404 may be a single logical entity or multiple entities from which all charter craft 412 are chartered out and delivered from. Alternatively, deliveries from operator 404 may be implemented by a network of distributed locations and delivery agents.

### (F)—Inventory Management

The approach described herein for chartering craft to customers provides superior charter craft inventory management to prior approaches. Specifically, the combination of the use of charter craft and charter location selection criteria provides for efficiencies allowing customers the flexibility to iteratively choose and optimize the various criteria (i.e. charter location, charter craft type, charter duration, charter price) to reflect their ideal charter experience.

By trading-off charter starting and ending dates, charter craft selection and charter location selection, the present invention provides great flexibility for managing a fleet of charter craft. Moreover, the greatest number of customers is provided with their most desired charter locations on their most desired charter craft. This approach therefore enables a superior matching of charter craft with the customers who desire to charter them.

By analyzing historical data, the present invention can also predict where customers are likely to demand or request charters, essentially highlighting popular charter locations that charter craft can then be moved to or prepared for transportation to, resulting in greater efficiencies, cost savings and higher profitability.

### (G)—Implementation Mechanisms

The approach described herein for chartering craft to customers is applicable to any type of charter application and (without limitation) is particularly well suited for Internet-based chartering of craft to customers. The invention may be implemented in hardware circuitry, in computer software, or a combination of hardware circuitry and computer software and is not limited to a particular hardware or software implementation.

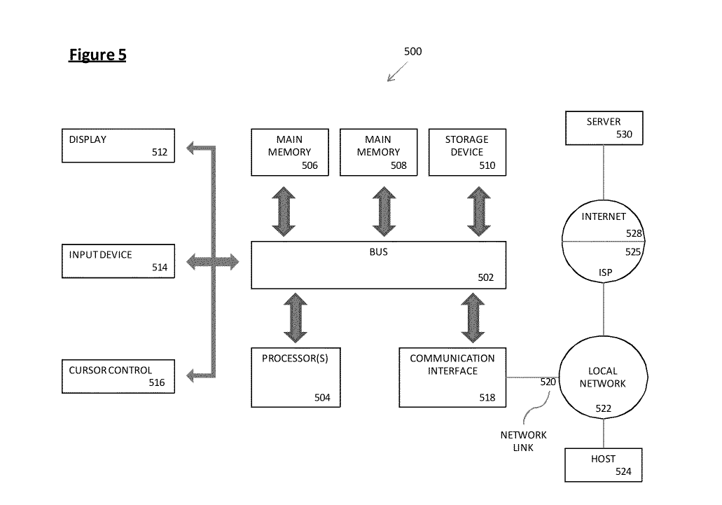

FIG. 5 is a block diagram that illustrates a computer system 500 upon which an embodiment of the invention may be implemented.

Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), a touch screen, or other display device, for displaying information to a computer user. In the event a non-visual display is desired, another form of output/display device can be utilized, including but not limited to audible devices. An input device 514, including alphanumeric, touch screen and/or other keys, or if desired, a voice-interface (with or without voice recognition) subsystem is coupled to bus 502 for communicating information and command selections to processor 504. Another type of user input device is cursor control 516, such as a mouse, a trackball, or cursor direction keys for communicating direction information and command selections to processor 504 and for controlling cursor or positional movement on display 512. This input device typically has two degrees of freedom in two axes, a first axis (e.g., x) and a second axis (e.g., y), that allows the device to specify positions in a plane, but is not limited to only two-dimensional devices and may include other devices which operate in three dimensional space or via a voice or motion-detection subsystem.

The invention is related to the use of computer system 500 for chartering craft to customers. According to one embodiment of the invention, the chartering of craft to customers is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, embodiments of the invention are not limited to any specific combination of hardware circuitry and software, neither are embodiments of the invention limited to any physical structure. Thus, embodiments of the invention may be physically distributed across one or more computing platforms; hosted in a “cloud” or placed on a virtualized computing environment.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for the chartering of craft to customers as described herein.

The received code may be executed by processor 504 as it is received, and/or stored in storage device 510, or other non-volatile storage for later execution. In this manner, computer system 500 may obtain application code in the form of a carrier wave.

The novel approach described herein for chartering craft to customers provides several advantages over prior approaches for chartering craft to customers. Unlike prior approaches, customers can select choose from a vast choice of charter locations unbounded by where charter operators have charter craft permanently located. Customers may specify different charter starting and ending locations, and may elect to stop at additional locations during their charters with the operator responsible for transporting their charter craft from one location to another. Customers may also specify what charter craft they wish to charter at their desired charter locations. Operators can deliver charter craft by multiple delivery modes if they are needed from one location to another in response to charter customers' needs and using inventory management functions, can also predict desired charter locations for pre-positioning of charter craft.

Furthermore, customers can adjust their various selection criteria and charter craft selection criteria to obtain their ideal combination of charter location, charter duration and charter craft choice, and receive price quotations that factor in all the various pertinent criteria.

The approach also allows superior inventory management of charter craft and offers the potential to significantly increase charter yields and revenues to charter operators and charter craft owners; including by predicting desired charter locations based on historical, heuristic or forecast data.

In the foregoing specification, the invention has been described as applicable to an implementation anticipating Internet based chartering with multimodal mechanisms for delivery of the charter craft, where the special advantages of the method are very compelling.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

What is claimed is:

1. A method for chartering readily transportable charter craft to customers that allows customers to specify charter locations without regard for the present location of the charter craft and upon receiving estimates for such charter craft, to confirm and purchase charter contracts for selected charter craft and locations. Wherein charter operators may enter and store information about: (a) charter craft including charter craft attributes, present and historical charter data, and a variety of other data about charter craft including maintenance information, (b) desirable charter locations including but not limited to: points-of-interest, weather data, and previous charter experiences. Wherein charter customers may specify desirable charter locations and receive price quotations for charter craft at those locations as well as other locations with similar criteria, as well as the ability to sort, group and filter the received information and to store it for future reference by registering themselves as well as select and confirm and complete an online payment for a charter craft for a chosen charter location.

2. A method for communications with and managing the relationship with charter customers before, during and after their charters. And wherein having received payment from a charter customer, pre-trip information can be provided to the customer, as well as other useful information and technical training on charter craft operation.

3. A system for chartering craft, the system comprising at least one central processing unit, at least one memory unit, at least one data storage unit and at least one network interface unit, the system further comprising: the capability to store and manage data on charter craft and their attributes and current and previous locations and wherein the data may be used for (a) unplanned, planned and preemptive charter craft maintenance purposes, (b) calculating charter rates for charter customers, (c) advertising purposes.

4. A system for chartering craft the system comprising at least one central processing unit, at least one memory unit, at least one data storage unit and at least one network interface unit, the system further comprising: the capability to store and manage data on charter locations and their attributes and other location specific data of interest wherein the data may be entered manually or automatically from the Internet and the data may be used for: (a) informational purposes and for calculating charter rates for charter customers, (b) advertising purposes.

5. A system for chartering craft, the system comprising at least one central processing unit, at least one memory unit, at least one data storage unit and at least one network interface unit, the system further comprising the capability to store and manage data on charter customers and to quote and store one or more charter rates to charter customers based on system data and wherein such data may be used for: (a) registering charter customers, promoting charters to charter customers, advertising purposes and various business intelligence purposes, (b) offering and storing charter quotations to charter customers, (c) accepting payments from such customers, and further managing all billing and customer care and other interactions with them and (d) providing training materials on charter craft to charter customers.
